(19) United States
(12) Patent Application Publication
(10) Pub. No.: US 2024/0203664 A1
(43) Pub. Date: Jun. 20, 2024

(54) IN CORE LARGE AREA CAPACITORS

(71) Applicant: Intel Corporation, Santa Clara, CA (US)

(72) Inventors: Yosef KORNBLUTH, Phoenix, AZ (US); Bainye Francoise ANGOUA, Phoenix, AZ (US); Whitney BRYKS, Tempe, AZ (US); Daniel ROSALES-YEOMANS, Gilbert, AZ (US); Aaditya Anand CANDADAI, Chandler, AZ (US); Holly CLINGAN, Chandler, AZ (US); Jade Sharee LEWIS, Phoenix, AZ (US); Patrick QUACH, Chandler, AZ (US); Srinivas V. PIETAMBARAM, Chandler, AZ (US)

(21) Appl. No.: 18/081,362

(22) Filed: Dec. 14, 2022

(51) Int. Cl. H01G 4/33; H01G 4/10

(52) U.S. Cl. CPC H01G 4/33; H01G 4/105

(57) ABSTRACT

Embodiments disclosed herein include a core for a package substrate. In an embodiment, the core comprises a first substrate with a first surface and a second surface, a first recess into the first surface of the first substrate, a first layer in the first recess, where the first layer is electrically conductive, a second layer over the first layer, where the second layer is a dielectric layer, and a third layer over the second layer, where the third layer is electrically conductive. In an embodiment, the core further comprises a second substrate with a third surface and a fourth surface, where the third surface of the second substrate faces the first surface of the first substrate, a second recess in the third surface of the second substrate, and a fourth layer in the second recess, where the fourth layer is electrically conductive, and the fourth layer contacts the third layer.

### TECHNICAL FIELD

Embodiments of the present disclosure relate to electronic packages, and more particularly to packaging architectures with multi-layer cores with capacitors at the interface between core layers.

### BACKGROUND

In electronic packaging, capacitors in the package substrate are used to deliver a constant voltage to one or more dies coupled to the package substrate, even as current varies. These capacitor architectures are often large and require a significant proportion of the area of the package substrate. In addition to the large area required for the capacitors, such integrated capacitors are expensive to manufacture. The high expense can be attributed to the processing operations needed to form the capacitors and/or expensive materials necessary to provide the needed capacitance.

In many instances, the capacitors are integrated into the buildup layers of the package substrate. Due to the area lost to capacitors, providing space for conductive routing is made more difficult. Additionally, since the leads of the capacitors are provided at different levels within the package substrate, it is more difficult to access the capacitor structure.

### BRIEF DESCRIPTION OF THE DRAWINGS

FIG. 1 is a cross-sectional illustration of a core for a package substrate that includes a capacitor integrated between a first sub-core layer and a second sub-core layer, in accordance with an embodiment.

FIG. 2 is a cross-sectional illustration of a core for a package substrate that includes a spacer between sub-core layers and an integrated capacitor between the sub-core layers, in accordance with an embodiment.

FIGS. 3A-3J are cross-sectional illustrations depicting a process for forming a core with an embedded capacitor structure, in accordance with an embodiment.

FIGS. 4A-4M are cross-sectional illustrations depicting a process for forming a core with an embedded capacitor structure, in accordance with an additional embodiment.

FIG. 5 is a cross-sectional illustration of an electronic system with a package substrate that includes a capacitor embedded in the core, in accordance with an embodiment.

FIG. 6 is a schematic of a computing device built in accordance with an embodiment.

### EMBODIMENTS OF THE PRESENT DISCLOSURE

Described herein are packaging architectures with multi-layer cores with capacitors at the interface between core layers, in accordance with various embodiments. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

As noted above, capacitor structures are necessary in electronic packaging architectures in order to provide a constant voltage to dies even as current varies. In existing solutions, the capacitors are formed in the buildup layers of the package substrate. This occupies valuable real estate that could otherwise be used for conductive routing. As such, the size of the package substrate may need to be increased in order to accommodate the embedded capacitors. Additionally, existing capacitor architectures require expensive materials and processing operations. Further, since the leads of the capacitor are on different layers, it becomes more difficult to access the capacitor.

Accordingly, embodiments disclosed herein include embedding the capacitor in the core of the package substrate. Other than over the top and bottom surface of the core, the core region generally does not include any horizontal routing. As such, previously unused real estate is used by embedding the capacitor within the core. In an embodiment, the materials for the capacitor may be more cost effective. Particularly, the footprint of the capacitor can be arbitrarily large, and expensive dielectric materials are not needed in order to provide a desired capacitance. In some instances the dielectric material may comprise silicon and oxygen (e.g., silicon oxide), aluminum and oxygen, or the like.

In one embodiment, the embedded capacitor may be provided between a first core sub-layer and a second core sub-layer. Recesses into the opposing surfaces of the first core sub-layer and the second core sub-layer can be formed. The capacitor may be set in the recesses. For example, a first layer that is conductive and a second layer that is a dielectric may be provided in one recess, and a third layer that is conductive may be provided in the other recess.

In another embodiment, the embedded capacitor may be provided between a first core sub-layer and a second core sub-layer without recesses. In such an embodiment, a spacer (e.g., an insulating spacer) may provide a standoff height between the first core sub-layer and the second core sub-layer. The capacitor can then be provided in the space between the sub-layers.

In some embodiments, the first core sub-layer and the second core sub-layer may be bonded to each other using a hybrid bonding process. As used herein, hybrid bonding may refer to bonding that includes an interface with at least two different material types. For example, hybrid bonding may refer to an interface that includes copper-to-copper bonds and glass-to-glass bonds. In some instances, the hybrid bonding may be implemented by providing a thin layer of copper over the dielectric layer of the capacitor in the bottom sub-layer. The thin layer of copper can then by hybrid bonded to the thicker copper layer in the top sub-layer. In some instances, the hybrid bonding may result in there being no discernable seam between the two surfaces. In other instances, a seam may be present at the hybrid bonding interface.

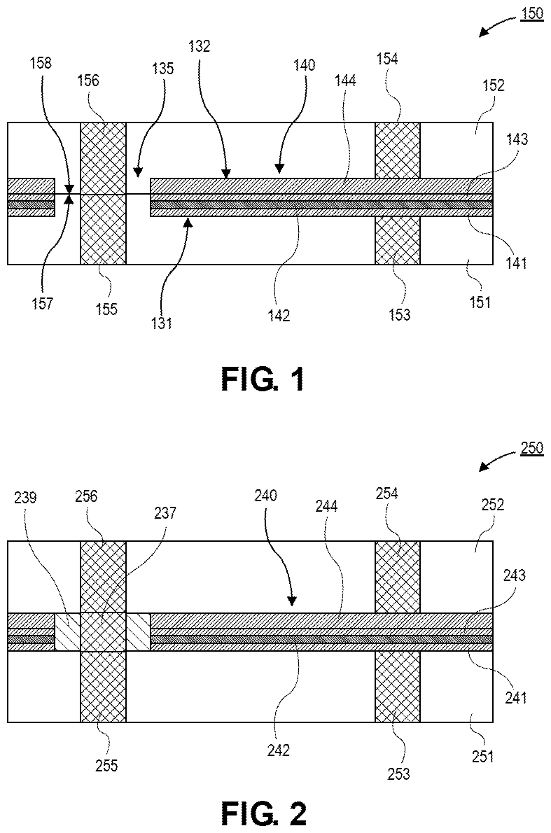

Referring now to FIG. 1, a cross-sectional illustration of a core 150 is shown, in accordance with an embodiment. In an embodiment, the core 150 may be a core that is used in a package substrate. For example, organic buildup layers (not shown) may be provided above and below the core 150. In an embodiment, the core 150 may comprise a pair of sub-core layers 151 and 152. The sub-core layers 151 and 152 may be any suitable core material. In a particular embodiment, the sub-core layers 151 and 152 may comprise glass. For example, the glass may be a borosilicate glass, a fused silica glass, or the like. In an embodiment, the first sub-core layer 151 may have an interface with the second sub-core layer 152. For example, surface 157 of the first sub-core layer 151 may directly contact surface 158 of the second sub-core layer 152. In the illustrated embodiment, a distinctive seam is provided at the interface. However, in other embodiments, the hybrid bonding process (described in greater detail below) may result in there being no discernable seam between the first sub-core layer 151 and the second sub-core layer 152.

In an embodiment, a capacitor 140 is embedded in the core 150. Particularly, the capacitor 140 may be provided in recesses 131 and 132 into the first sub-core layer 151 and the second sub-core layer 152, respectively. In an embodiment, the depth of the recesses 131 and 132 may be substantially similar to each other. In other embodiments, the recesses 131 and 132 may have different depths. The first recess 131 may be substantially aligned with the second recess 132. That is, edges of the first recess 131 may be substantially aligned with edges of the second recess 132.

In an embodiment, a first layer 141 may be provided in the first recess 131. The first layer 141 may comprise a conductive material, such as copper or the like. The first layer 141 may have any suitable thickness. For example, the first layer 141 may have a thickness between approximately 1 nm and approximately 500 nm. As used herein, “approximately” may refer to a range of values within ten percent of the stated value. For example approximately 500 nm may refer to a range between 450 nm and 550 nm.

A second layer 142 may be provided over the first layer 141. The second layer 142 may be a dielectric material. The dielectric material of the second layer 142 may comprise silicon and oxygen (e.g., silicon dioxide), aluminum and oxygen, or the like. Though, other materials may be used. For example, dielectric layers with dielectric constants higher than that of silicon dioxide may be used in some embodiments. In an embodiment, the second layer 142 may have a thickness between approximately 1 nm and approximately 50 nm.

In an embodiment, a third layer 143 may be provided over the second layer 143. The third layer 143 may also be a conductive layer. The third layer 143 is a layer that enables the hybrid bonding. The third layer 143 may have a thickness between approximately 1 nm and approximately 50 nm in some embodiments.

In an embodiment, a fourth layer 144 may be provided in the second recess 132. The fourth layer 144 may be the same material as the third layer 143 (e.g., copper). In an embodiment, the third layer 143 may include a thickness that is between approximately 1 nm and approximately 300 nm. In an embodiment, the fourth layer 144 may be hybrid bonded to the third layer 143. In the illustrated embodiment, a distinct seam is provided between the fourth layer 144 and the third layer 143. However, in other embodiments, the third layer 143 and the fourth layer 144 may be combined in a seamless fashion. In such instances, the presence of both the third layer 143 and the fourth layer 144 can be inferred since the combined thickness of the third layer 143 and the fourth layer 144 will be greater than the depth of the second recess 132. That is, a portion of the combined layer will extend into the first recess 131 in the first sub-core layer 151. In an embodiment, the total thickness of the capacitor 140 may be between approximately 10 nm and approximately 1,000 nm.

In an embodiment, the capacitor 140 may include one or more holes 135. The holes may be provided around vias 155 and 156. As such, electrical connection through the core 150 can be made even when large area embedded capacitors 140 are formed. In an embodiment, the distance between the edge of the vias 155 and 156 and the edge of the embedded capacitor 140 may be between approximately 1 μm and approximately 50 μm. Additionally, while a seam between via 155 and via 156 is shown, in some embodiments hybrid bonding may result in a seamless connection between via 155 and via 156. Additional vias 153 and 154 may be provided in order to access the capacitor 140. For example, via 153 may be coupled to the first layer 141, and via 154 may be coupled to the fourth layer 144.

Referring now to FIG. 2, a cross-sectional illustration of a core 250 is shown, in accordance with an embodiment. In an embodiment, the core 250 may comprise a first sub-core layer 251 and a second sub-core layer 252. The sub-core layers 251 and 252 may comprise glass in some embodiments. In an embodiment, the sub-core layers 251 may be spaced apart from each other by a spacer 239. That is, the first sub-core layer 251 may not directly contact the second sub-core layer 252.

The spaced apart relationship of the first sub-core layer 251 and the second sub-core layer 252 allow for a capacitor 240 to be formed between the first sub-core layer 251 and the second sub-core layer 252. In an embodiment, the capacitor 240 may include a first layer 241, a second layer 242, a third layer 243, and a fourth layer 242. The first layer 241, the third layer 243, and the fourth layer 242 may comprise a conductive material, such as copper or the like. The second layer 242 may comprise a dielectric material such as one comprising silicon and oxygen, aluminum and oxygen, or any other high-k dielectric material. In the illustrated embodiment, a seam is provided between the third layer 243 and the fourth layer 244. Though, in other embodiments, the interface between the third layer 243 and the fourth layer 244 may be substantially seamless. For example, hybrid bonding processes may result in there not being a seam between the third layer 243 and the fourth layer 244. In an embodiment, the thicknesses of the layers 241-244 may be substantially similar to thicknesses of layers 141-144 described in greater detail above. In an embodiment, a total thickness of the capacitor 240 may be between approximately 10 nm and approximately 1,000 nm.

In an embodiment, vias 256 and 255 may be provided to enable electrical connection between the top and bottom surfaces of the core 250. In a particular embodiment, the via 255 is coupled to the via 256 by a third via 237. The third via 237 may be provided within the spacer 239. While shown as three distinct vias 255, 256, and 237, it is to be appreciated that one or both of the interfaces may be seamless in some embodiments. Additionally, via 253 may be coupled to the first layer 241 and via 254 may be coupled to the fourth layer 244 in order to provide electrical access to the capacitor 240.

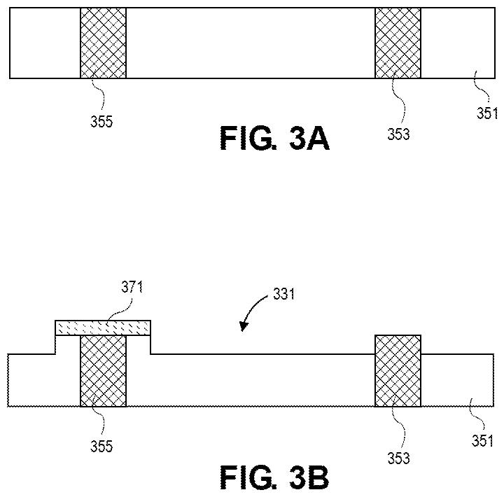

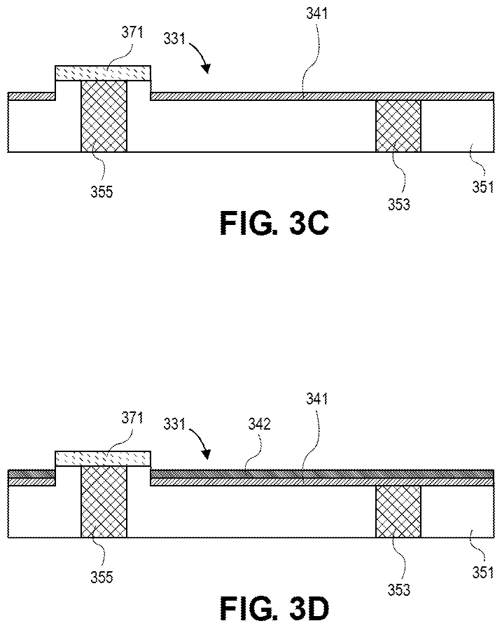

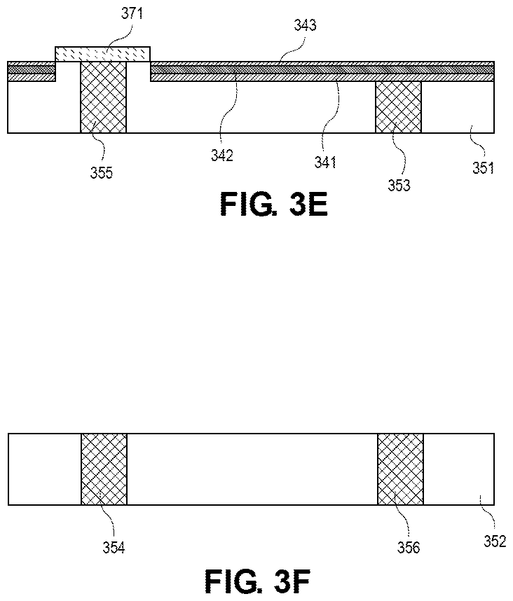

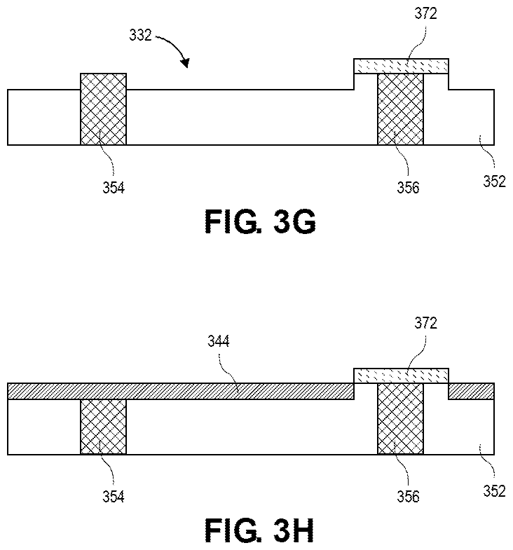

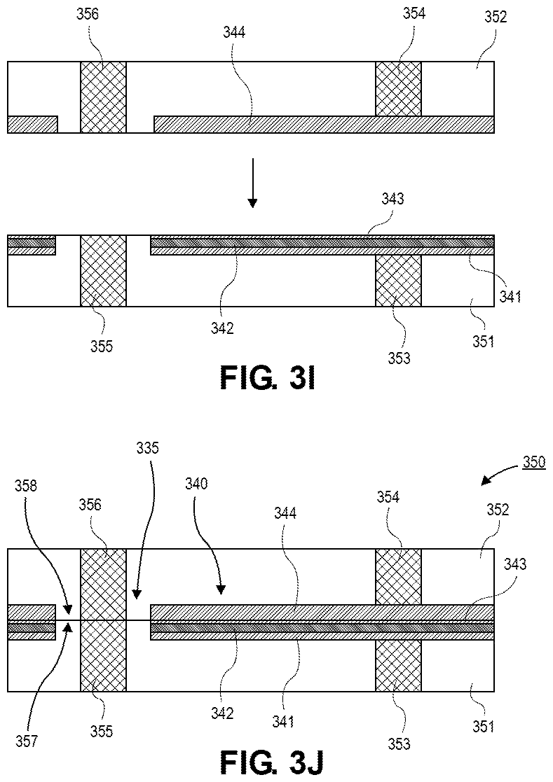

Referring now to FIGS. 3A-3J, a series of cross-sectional illustrations depicting a process for forming a core is shown, in accordance with an embodiment. In an embodiment, the core fabricated in FIGS. 3A-3J may be substantially similar to the core 150 described above with respect to FIG. 1.

Referring now to FIG. 3A, a cross-sectional illustration of a first sub-core layer 351 is shown, in accordance with an embodiment. In an embodiment, the first sub-core layer 351 may comprise glass or any other suitable core material. In an embodiment, a pair of vias 353 and 355 may be provided through the sub-core layer 351. The via 353 may be used to contact a capacitor structure formed in subsequent processing operations, and the via 355 may be part of a through core via that passes entirely through the assembled core.

Referring now to FIG. 3B, a cross-sectional illustration of the first sub-core layer 351 after a first recess 331 is formed is shown, in accordance with an embodiment. In an embodiment, the first recess 331 may have a depth that is between approximately 5 nm and approximately 500 nm. In a particular embodiment, the depth of the first recess 331 may be approximately 25 nm or less. In an embodiment, the via 355 and adjacent portions of the first sub-core layer 351 may be masked with a resist layer 371. The resist layer 371 may extend out up to approximately 50 μm away from the edge of the via 355.

Referring now to FIG. 3C, a cross-sectional illustration of the first sub-core layer 351 after a first layer 341 is deposited is shown, in accordance with an embodiment. In an embodiment, the first layer 341 may be an electrically conductive material, such as copper or the like. In an embodiment, the first layer 341 may have a thickness that is between approximately 3 nm and approximately 200 nm. In the illustrated embodiment, the thickness of the first layer 341 is less than a depth of the first recess 331. Though, in other embodiments, the first layer 341 may have a thickness that is equal to or greater than a depth of the first recess 331.

Referring now to FIG. 3D, a cross-sectional illustration of the first sub-core layer 351 after a second layer 342 is deposited is shown, in accordance with an embodiment. In an embodiment, the second layer 342 may be a dielectric material. For example, the second layer 342 may comprise silicon and oxygen, aluminum and oxygen, or any other high-k dielectric material. In an embodiment, the thickness of the second layer 342 may be between approximately 1 nm and approximately 100 nm. In a particular embodiment, the second layer 342 may be thinner than the first layer 341.

Referring now to FIG. 3E, a cross-sectional illustration of the first sub-core layer 351 after a third layer 343 is deposited is shown, in accordance with an embodiment. In an embodiment, the third layer 343 may comprise a conductive material, such as copper or the like. In an embodiment, the third layer 343 may have a thickness between approximately 1 nm and approximately 50 nm. In an embodiment, after the third layer 343 is formed, the resist 371 may be removed and a top surface of the first sub-core layer 351 may be planarized (e.g., with a chemical mechanical polishing (CMP) process).

Referring now to FIG. 3F, a cross-sectional illustration of a second sub-core layer 352 is shown, in accordance with an embodiment. In an embodiment, the second sub-core layer 352 may comprise the same material as the first sub-core layer 351, such as glass. In an embodiment, vias 354 and 356 may be provided through a thickness of the second sub-core layer 352.

Referring now to FIG. 3G, a cross-sectional illustration of the second sub-core layer 352 after a second recess 332 is formed is shown, in accordance with an embodiment. In an embodiment, the second recess 332 may be patterned outside of a resist 372 that is provided over the via 356. The width of the resist 372 may be substantially similar to the width of the resist 371 described in greater detail above.

Referring now to FIG. 3H, a cross-sectional illustration of the second sub-core layer 352 after a fourth layer 344 is deposited in the second recess 332 is shown, in accordance with an embodiment. In an embodiment, the fourth layer 344 may comprise a conductive material, such as copper or the like. In an embodiment, the fourth layer 344 comprises the same material as the third layer 343 in order to enable hybrid bonding.

Referring now to FIG. 3I, a cross-sectional illustration depicting the assembly of the first sub-core layer 351 with the second sub-core layer 352 is shown, in accordance with an embodiment. As shown, the second sub-core layer 352 is flipped over so that fourth layer 344 faces the third layer 343. Additionally, the via 356 is aligned with the via 355. As indicated by the arrow, the second sub-core layer 352 is brought down so that the second sub-core layer 352 contacts the first sub-core layer 351.

Referring now to FIG. 3J, a cross-sectional illustration after hybrid bonding the first sub-core layer 351 to the second sub-core layer 352 to form core 350 is shown, in accordance with an embodiment. As shown, the capacitor 340 includes a first layer 341, a second layer 342, a third layer 343, and a fourth layer 344. In some embodiments, there may be no seam between the third layer 343 and the fourth layer 344. Similarly, there may be no seam between the via 355 and the via 356. Further, the seam at the interface between surfaces 357 and 358 may be omitted in some instances. However, a hole 335 through the capacitor 340 will remain to allow for electrical coupling through a thickness of the core 350 (e.g., using vias 355 and 356).

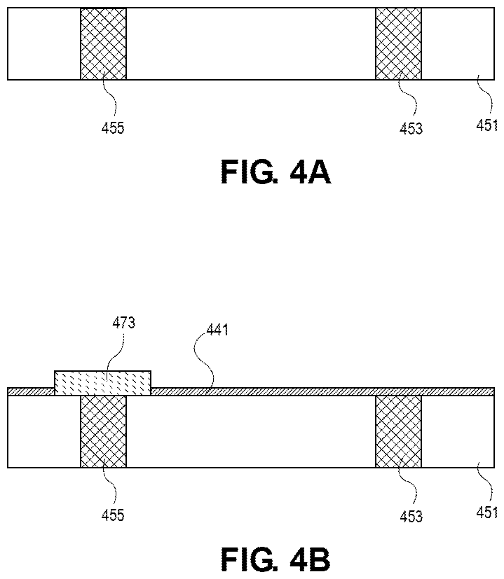

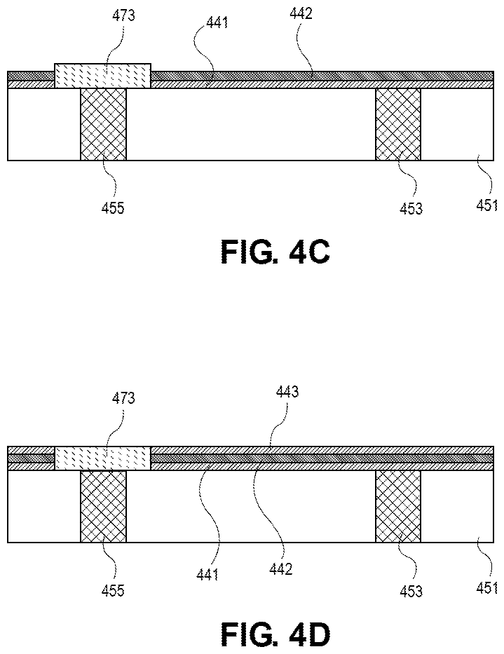

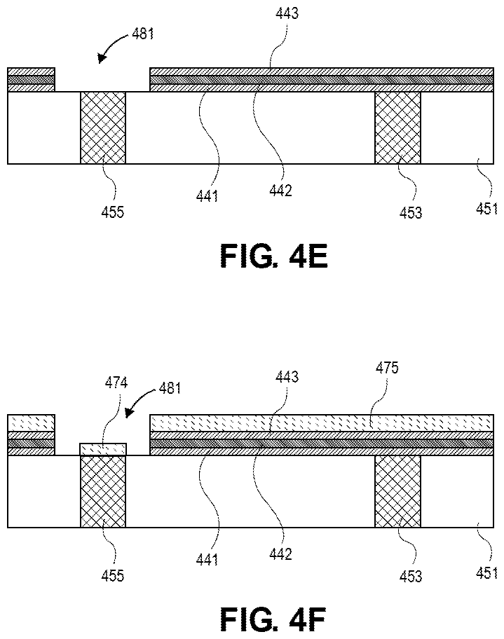

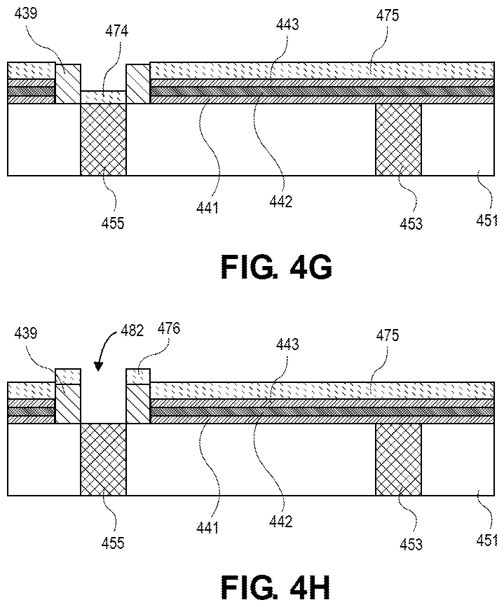

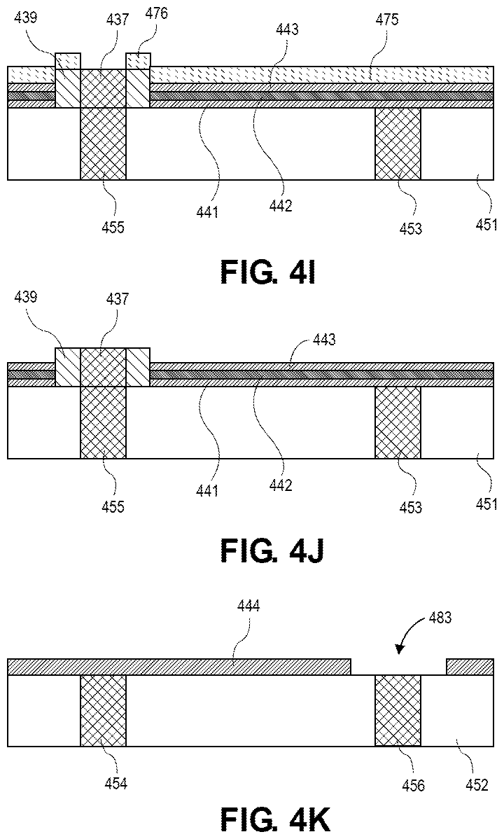

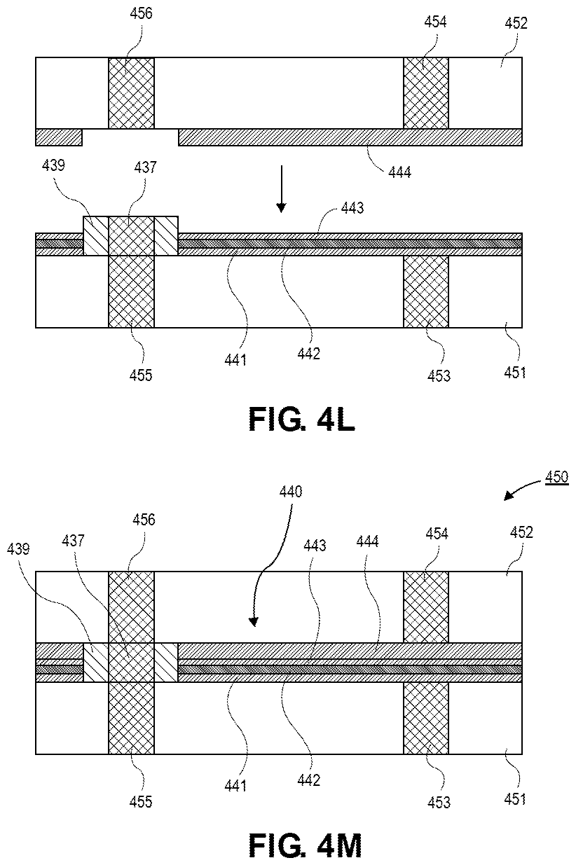

Referring now to FIGS. 4A-4M, a series of cross-sectional illustrations depicting a process for forming a core is shown, in accordance with an embodiment. In an embodiment, the core fabricated in FIGS. 4A-4M may be substantially similar to the core 250 described above with respect to FIG. 2.

Referring now to FIG. 4A, a cross-sectional illustration of a first sub-core layer 451 is shown, in accordance with an embodiment. In an embodiment, the first sub-core layer 451 may comprise glass or any other suitable core material. In an embodiment, a pair of vias 453 and 455 may be provided through the sub-core layer 451. The via 453 may be used to contact a capacitor structure formed in subsequent processing operations, and the via 455 may be part of a through core via that passes entirely through the assembled core.

Referring now to FIG. 4B, a cross-sectional illustration of the first sub-core layer 451 after a first layer 441 is formed is shown, in accordance with an embodiment. In an embodiment, the first layer 441 may comprise a conductive material, such as copper or the like. In an embodiment, a resist 473 is provided over the via 455. The resist 473 may have a width that is greater than the width of the via 455.

Referring now to FIG. 4C, a cross-sectional illustration of the first sub-core layer 451 after a second layer 442 is deposited is shown, in accordance with an embodiment. In an embodiment, the second layer 442 may be a dielectric material, such as one comprising silicon and oxygen, aluminum and oxygen, or any other high-k dielectric material. In an embodiment, a thickness of the second layer 442 may be less than a thickness of the first layer 441.

Referring now to FIG. 4D, a cross-sectional illustration of the first sub-core layer 451 after a third layer 443 is deposited is shown, in accordance with an embodiment. In an embodiment, the third layer 443 may comprise a conductive material, such as copper or the like. In an embodiment, the third layer 443 may have a thickness that is up to approximately 100 nm.

Referring now to FIG. 4E, a cross-sectional illustration of the first sub-core layer 451 after the resist 473 is removed is show, in accordance with an embodiment. In an embodiment, the resist 473 may be removed with any suitable resist stripping or etching process. Removal of the resist 473 results in a hole 481 formed through the layers 441-443. The hole 481 may be centered over the via 455.

Referring now to FIG. 4F, a cross-sectional illustration of the first sub-core layer 451 after a second resist 475 and 474 is applied over selected portions of the first sub-core layer 451 is shown, in accordance with an embodiment. Particularly, resist 475 is provided over the third layer 443, and resist 474 is provided over the via 455. This leaves outer portions of the hole 481 exposed.

Referring now to FIG. 4G, a cross-sectional illustration of the first sub-core layer 451 after a spacer 439 is deposited in the hole 481 on the sides of the resist 474 is shown, in accordance with an embodiment. The spacer 439 may be an insulating material. In a particular embodiment, the insulating material of spacer 439 may comprise silicon and oxygen or aluminum and oxygen in some embodiments. Though, other insulating materials may be used as well.

Referring now to FIG. 4H, a cross-sectional illustration of the first sub-core layer 451 after the resist 474 is removed to expose the via 455 is shown, in accordance with an embodiment. After the via 455 is exposed, the top surfaces of the spacer 439 may be covered with a resist 476. Accordingly, a hole 482 is provided to expose the top surface of the via 455.

Referring now to FIG. 4I, a cross-sectional illustration of the first sub-core layer 451 after a via 437 is formed in the hole 482 is shown, in accordance with an embodiment. The via 437 may be plated with any suitable plating process. In some embodiments, a distinct seam is visible between the via 455 and the via 437. In other embodiments, there may not be a visible seam between the via 455 and the via 437.

Referring now to FIG. 4J, a cross-sectional illustration of the first sub-core layer 451 after the resists 475 and 476 are removed is shown, in accordance with an embodiment. In an embodiment, the resists 475 and 476 may be removed with a resist stripping process, a resist etching process, or the like. In an embodiment, the removal of the resists 475 and 476 exposes the third layer 443 and the spacer 439.

Referring now to FIG. 4K, a cross-sectional illustration of a second sub-core layer 452 is shown, in accordance with an embodiment. In an embodiment, the second sub-core layer 452 may comprise glass or the like. In a particular embodiment, the second sub-core layer 452 may be the same material as the first sub-core layer 451. The second sub-core layer 452 may comprise vias 454 and 456. A fourth layer 444 may be deposited over the top surface of the second sub-core layer 452. A hole 483 in the fourth layer 444 may be provided over the via 456. The hole 483 may be sized to receive the spacer 439 on the first sub-core layer 451.

Referring now to FIG. 4L, a cross-sectional illustration depicting the process of attaching the first sub-core layer 451 to the second sub-core layer 452 is shown, in accordance with an embodiment. As shown, the second sub-core layer 452 is flipped upside down in order to align the fourth layer 444 with the third layer 443. Similarly, the via 456 is aligned with the via 437 between spacers 439.

Referring now to FIG. 4M, a cross-sectional illustration depicting the core 450 after hybrid bonding is shown, in accordance with an embodiment. In an embodiment, the hybrid bonding may occur at the interface between the third layer 443 and the fourth layer 444, and at the interface between the spacer 439 and the second sub-core layer 452. In the illustrated embodiment, seams are present at the interfaces. Though, seamless connections may also be included in some instances. For example, there may not be a discernable seam between the third layer 443 and the fourth layer 444 in some embodiments. In an embodiment, the via 456 may also be hybrid bonded to the via 437. Similarly, the interface between the via 456 and the via 437 may have a seam or may be seamless.

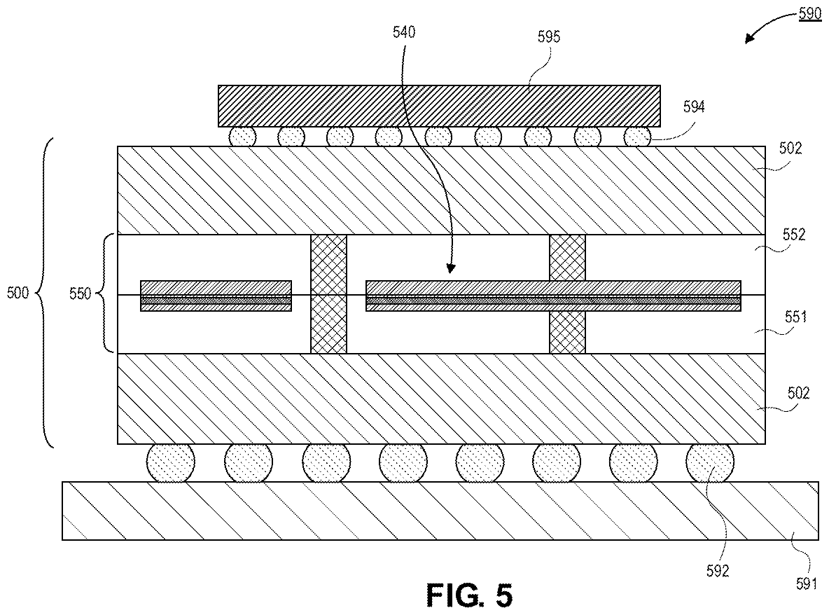

Referring now to FIG. 5, a cross-sectional illustration of an electronic system 590 is shown, in accordance with an embodiment. In an embodiment, the electronic system 590 may comprise a board 591, such as a printed circuit board (PCB). The board 591 may be coupled to a package substrate 500 by interconnects 592. The interconnects 592 may be solder balls, sockets, or the like. In an embodiment, the package substrate 500 may comprise a core 550 and buildup layers 502 above and below the core 550.

In an embodiment, the core 550 may comprise a pair of sub-core layers 551 and 552. The sub-core layers 551 and 552 may comprise glass ore the like. In an embodiment, a capacitor 540 may be embedded in the core 550 between the sub-core layers 551 and 552. In the illustrated embodiment, the capacitor 540 sits in recesses in the sub-core layers 551 and 552. Though, in other embodiments, the capacitor 540 may be entirely between the surfaces of the sub-core layers 551 and 552. In an embodiment, the sub-core layer 551 may be hybrid bonded to the sub-core layer 552.

In an embodiment, a die 595 is coupled to the package substrate 500. For example, first level interconnects (FLIs) 594 may couple the die 595 to the package substrate 500. In an embodiment, the die 595 may be a compute die, a memory die, or any other type of die. Further, a plurality of dies 595 may be coupled to the package substrate 500 in some embodiments.

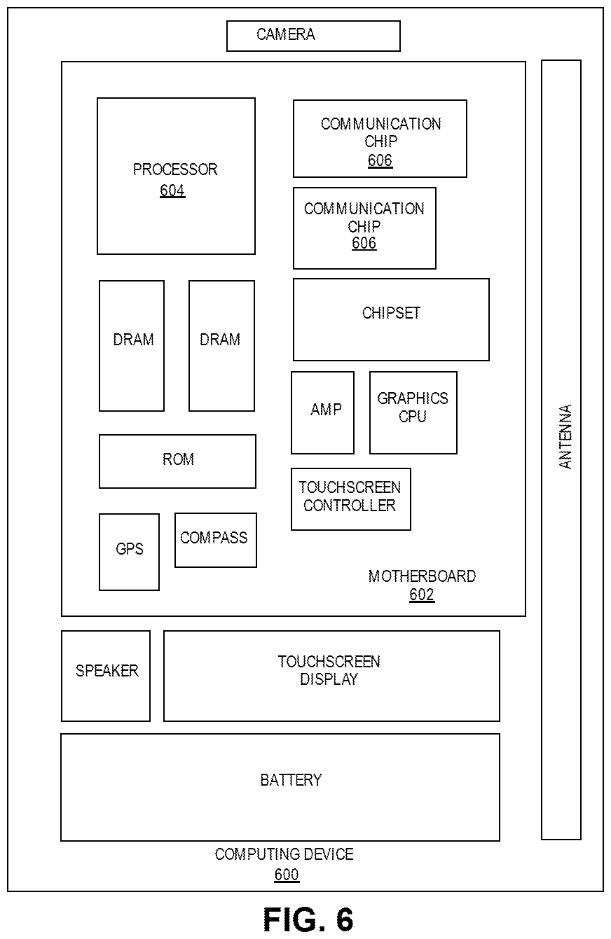

FIG. 6 illustrates a computing device 600 in accordance with one implementation of the invention. The computing device 600 houses a board 602. The board 602 may include a number of components, including but not limited to a processor 604 and at least one communication chip 606. The processor 604 is physically and electrically coupled to the board 602. In some implementations the at least one communication chip 606 is also physically and electrically coupled to the board 602. In further implementations, the communication chip 606 is part of the processor 604.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 606 enables wireless communications for the transfer of data to and from the computing device 600. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 606 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 600 may include a plurality of communication chips 606. For instance, a first communication chip 606 may be dedicated to shorter range wireless communications such as Wi-Fi and Bluetooth and a second communication chip 606 may be dedicated to longer range wireless communications such as GPS, EDGE, GPRS, CDMA, WiMAX, LTE, Ev-DO, and others.

The processor 604 of the computing device 600 includes an integrated circuit die packaged within the processor 604. In some implementations of the invention, the integrated circuit die of the processor may be part of an electronic package that comprises a package substrate with a core that includes a pair of sub-core layers and a capacitor between the sub-core layers, in accordance with embodiments described herein. The term “processor” may refer to any device or portion of a device that processes electronic data from registers and/or memory to transform that electronic data into other electronic data that may be stored in registers and/or memory.

The communication chip 606 also includes an integrated circuit die packaged within the communication chip 606. In accordance with another implementation of the invention, the integrated circuit die of the communication chip may be part of an electronic package that comprises a package substrate with a core that includes a pair of sub-core layers and a capacitor between the sub-core layers, in accordance with embodiments described herein.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

Example 1: a core for a package substrate, comprising: a first substrate with a first surface and a second surface; a first recess into the first surface of the first substrate; a first layer in the first recess, wherein the first layer is electrically conductive; a second layer over the first layer, wherein the second layer is a dielectric layer; and a third layer over the second layer, wherein the third layer is electrically conductive; a second substrate with a third surface and a fourth surface, wherein the third surface of the second substrate faces the first surface of the first substrate; a second recess in the third surface of the second substrate; and a fourth layer in the second recess, wherein the fourth layer is electrically conductive, and wherein the fourth layer contacts the third layer.

Example 2: the core of Example 1, wherein a portion of the first surface directly contacts a portion of the third surface.

Example 3: the core of Example 1 or Example 2, further comprising: a first via in the first substrate, wherein the first via passes through a hole in the first layer, the second layer, and the third layer; and a second via in the second substrate, wherein the second via passes through a hole in the fourth layer, and wherein the first via directly contacts the second via.

Example 4: the core of Example 3, wherein there is no seam at an interface between the first via and the second via.

Example 5: the core of Examples 1-3, wherein there is no seam at an interface between the third layer and the fourth layer.

Example 6: the core of Examples 1-5, wherein the third layer is thinner than the first layer.

Example 7: the core of Example 6, wherein the first layer has a thickness between approximately 1 nm and approximately 500 nm, and wherein the third layer has a thickness between approximately 1 nm and approximately 50 nm.

Example 8: the core of Examples 1-7, wherein the second layer has a thickness between approximately 1 nm and approximately 50 nm.

Example 9: the core of Examples 1-8, wherein the second layer comprises silicon and oxygen, or aluminum and oxygen.

Example 10: the core of Examples 1-9, wherein the first recess is aligned with the second recess.

Example 11: the core of Examples 1-10, wherein the first substrate and the second substrate comprise glass.

Example 12: the core of Examples 1-11, wherein the core is part of a package substrate that is coupled to a processor of a computing system.

Example 13: a core for a package substrate, comprising: a first substrate with a first via; a second substrate with a second via, wherein the first via is positioned over the second via; a spacer between the first substrate and the second substrate, where a third via passes through the spacer and connects the first via to the second via; and a capacitor between the first substrate and the second substrate, wherein the capacitor surrounds the spacer.

Example 14: the core of Example 13, wherein the capacitor comprises: a first layer on the first substrate, wherein the first layer is electrically conductive; a second layer on the first layer, wherein the second layer is a dielectric layer; and a third layer on the second layer, wherein the third layer is electrically conductive.

Example 15: the core of Example 14, wherein the third layer comprises a fourth layer and a fifth layer.

Example 16: the core of Example 15, wherein a visible seam is provided between the fourth layer and the fifth layer.

Example 17: the core of Examples 13-16, wherein the first substrate and the second substrate comprise glass.

Example 18: the core of Examples 13-17, wherein the second layer comprises silicon and oxygen or aluminum and oxygen.

Example 19: the core of Examples 13-18, wherein a thickness of the capacitor is between approximately 10 nm and approximately 1,000 nm.

Example 20: the core of Examples 13-19, wherein buildup layers are provided above and below the core to form the package substrate, wherein a die is coupled to the package substrate, and wherein the package substrate is coupled to a board.

Example 21: a core, comprising: a first substrate, wherein the first substrate comprises glass; a second substrate over the first substrate, wherein the second substrate comprises glass; a first recess into the first substrate; a second recess into the second substrate, wherein the second recess is over the first recess; and a capacitor filling the first recess and the second recess.

Example 22: the core of Example 21, wherein a first layer that is electrically conductive and a second layer that is a dielectric are provided in the first recess, and wherein a third layer that is electrically conductive is provided in the first recess and the second recess.

Example 23: an electronic system, comprising: a board; a package substrate with a core coupled to the board, wherein the core comprises: a first substrate; a second substrate over the first substrate; and a capacitor between the first substrate and the second substrate; and a die coupled to the package substrate.

Example 24: the electronic system of Example 23, wherein the first substrate and the second substrate comprise glass.

Example 25: the electronic system of Example 23 or Example 24, wherein the capacitor is set into recesses into the first substrate and the second substrate.

What is claimed is:

1. A core for a package substrate, comprising:
a first substrate with a first surface and a second surface;
a first recess into the first surface of the first substrate;
a first layer in the first recess, wherein the first layer is electrically conductive;
a second layer over the first layer, wherein the second layer is a dielectric layer; and
a third layer over the second layer, wherein the third layer is electrically conductive;
a second substrate with a third surface and a fourth surface, wherein the third surface of the second substrate faces the first surface of the first substrate;
a second recess in the third surface of the second substrate; and
a fourth layer in the second recess, wherein the fourth layer is electrically conductive, and wherein the fourth layer contacts the third layer.

2. The core of claim 1, wherein a portion of the first surface directly contacts a portion of the third surface.

3. The core of claim 1, further comprising:
a first via in the first substrate, wherein the first via passes through a hole in the first layer, the second layer, and the third layer; and
a second via in the second substrate, wherein the second via passes through a hole in the fourth layer, and wherein the first via directly contacts the second via.

4. The core of claim 3, wherein there is no seam at an interface between the first via and the second via.

5. The core of claim 1, wherein there is no seam at an interface between the third layer and the fourth layer.

6. The core of claim 1, wherein the third layer is thinner than the first layer.

7. The core of claim 6, wherein the first layer has a thickness between approximately 1 nm and approximately 500 nm, and wherein the third layer has a thickness between approximately 1 nm and approximately 50 nm.

8. The core of claim 1, wherein the second layer has a thickness between approximately 1 nm and approximately 50 nm.

9. The core of claim 1, wherein the second layer comprises silicon and oxygen, or aluminum and oxygen.

10. The core of claim 1, wherein the first recess is aligned with the second recess.

11. The core of claim 1, wherein the first substrate and the second substrate comprise glass.

12. The core of claim 1, wherein the core is part of a package substrate that is coupled to a processor of a computing system.

13. A core for a package substrate, comprising:
a first substrate with a first via;
a second substrate with a second via, wherein the first via is positioned over the second via;
a spacer between the first substrate and the second substrate, where a third via passes through the spacer and connects the first via to the second via; and
a capacitor between the first substrate and the second substrate, wherein the capacitor surrounds the spacer.

14. The core of claim 13, wherein the capacitor comprises:
a first layer on the first substrate, wherein the first layer is electrically conductive;
a second layer on the first layer, wherein the second layer is a dielectric layer; and
a third layer on the second layer, wherein the third layer is electrically conductive.

15. The core of claim 14, wherein the third layer comprises a fourth layer and a fifth layer.

16. The core of claim 15, wherein a visible seam is provided between the fourth layer and the fifth layer.

17. The core of claim 13, wherein the first substrate and the second substrate comprise glass.

18. The core of claim 13, wherein the second layer comprises silicon and oxygen or aluminum and oxygen.

19. The core of claim 13, wherein a thickness of the capacitor is between approximately 10 nm and approximately 1,000 nm.

20. The core of claim 13, wherein buildup layers are provided above and below the core to form the package substrate, wherein a die is coupled to the package substrate, and wherein the package substrate is coupled to a board.

21. A core, comprising:
a first substrate, wherein the first substrate comprises glass;
a second substrate over the first substrate, wherein the second substrate comprises glass;
a first recess into the first substrate;
a second recess into the second substrate, wherein the second recess is over the first recess; and
a capacitor filling the first recess and the second recess.

22. The core of claim 21, wherein a first layer that is electrically conductive and a second layer that is a dielectric are provided in the first recess, and wherein a third layer that is electrically conductive is provided in the first recess and the second recess.

23. An electronic system, comprising:
a board;
a package substrate with a core coupled to the board, wherein the core comprises:
a first substrate;
a second substrate over the first substrate; and
a capacitor between the first substrate and the second substrate; and
a die coupled to the package substrate.

24. The electronic system of claim 23, wherein the first substrate and the second substrate comprise glass.

25. The electronic system of claim 23, wherein the capacitor is set into recesses into the first substrate and the second substrate.
